(19) United States
(12) Patent Application Publication
(10) Pub. No.: US 2025/0211934 A1
(43) Pub. Date: Jun. 26, 2025

(54) COMPUTER SYSTEM, METHOD, AND PROGRAM

(71) Applicant: Sony Interactive Entertainment Inc., Tokyo (JP)

(72) Inventor: Tetsugo INADA, Tokyo (JP)

(73) Assignee: Sony Interactive Entertainment Inc., Tokyo (JP)

(21) Appl. No.: 18/845,452

(22) PCT Filed: Mar. 18, 2022
(86) PCT No.: PCT/JP2022/012577

§ 371 Date: Sep. 10, 2024

(51) Int. Cl. H04S 7/00; H04N 23/61

(52) U.S. Cl. CPC H04S 7/305; H04N 23/61

(57) ABSTRACT

Provided is a computer system for detecting vibrations generated by sound waves in a space, the computer system including a memory for storing a program code and a processor for performing an operation in accordance with the program code, the operation including analyzing the vibrations of an object in the space in reference to an event signal generated by an event-based vision sensor, and reconstructing sound data from a result of the analysis of the vibrations.

### TECHNICAL FIELD

The present invention relates to a computer system, a method, and a program.

### BACKGROUND ART

A technology that detects, from a high frame rate moving image, minute vibrations generated on a surface of an object when sound hits the object and that partially reconstructs sound from the vibrations is known. Such a technology is described, for example, in NPL 1.

### PATENT LITERATURE

### Non Patent Literature

[NPL 1]
Abe Davis et al., “The Visual Microphone: Passive Recovery of Sound from Video,” ACM Transactions on Graphics (Proc. SIGGRAPH), Vol. 33, No. 4, pp. 79:1-79:10, 2014

### SUMMARY

### Technical Problem

Yet, moving images increase in data amount as the frame rate increases, so that it is difficult to detect vibrations and reconstruct sound with practical resource amounts and sufficient accuracy by use of such a technology as described in NPL 1.

As such, an object of the present invention is to provide a computer system, a method, and a program that are capable of increasing detection accuracy while reducing the resource amount in detecting vibrations that are generated by sound waves in a space, with use of a vision sensor.

### Solution to Problem

According to an aspect of the present invention, provided is a computer system for detecting vibrations that are generated by sound waves in a space, the computer including a memory for storing a program code, and a processor for performing an operation in accordance with the program code, in which the operation includes analyzing vibrations of an object in the space in reference to an event signal generated by an event-based vision sensor, and reconstructing sound data from a result of analysis of the vibrations.

According to another aspect of the present invention, provided is a method for detecting vibrations that are generated by sound waves in a space, the method including, by an operation performed by a processor in accordance with a program code stored in a memory, analyzing vibrations of an object in the space in reference to an event signal generated by an event-based vision sensor, and reconstructing sound data from a result of the analysis of the vibrations.

According to a further aspect of the present invention, provided is a program for detecting vibrations that are generated by sound waves in a space, the program including, by an operation performed by a processor in accordance with the program, analyzing vibrations of an object in the space in reference to an event signal generated by an event-based vision sensor, and reconstructing sound data from a result of the analysis of the vibrations.

### BRIEF DESCRIPTION OF DRAWINGS

FIG. 1 is a view illustrating an example of a system according to an embodiment of the present invention.

FIG. 2 is a view illustrating an apparatus configuration of the system depicted in FIG. 1.

FIG. 3 is a flowchart illustrating a general flow of a process performed in the system depicted in FIG. 1.

FIG. 4 is a flowchart illustrating an example of pre-processing in the process depicted in FIG. 3.

FIG. 5 is a flowchart illustrating a first example of post-processing in the process depicted in FIG. 3.

FIG. 6 is a flowchart illustrating a second example of the post-processing in the process depicted in FIG. 3.

FIG. 7 is a view for describing a principle of the processing depicted in FIG. 6.

FIG. 8 is a view for describing the principle of the processing depicted in FIG. 6.

### DESCRIPTION OF EMBODIMENT

Some embodiments of the present invention will hereinafter be described in detail with reference to the attached drawings. Note that, in the present description and drawings, constituent elements having substantially identical functions and configurations are denoted by identical reference signs to omit redundant description.

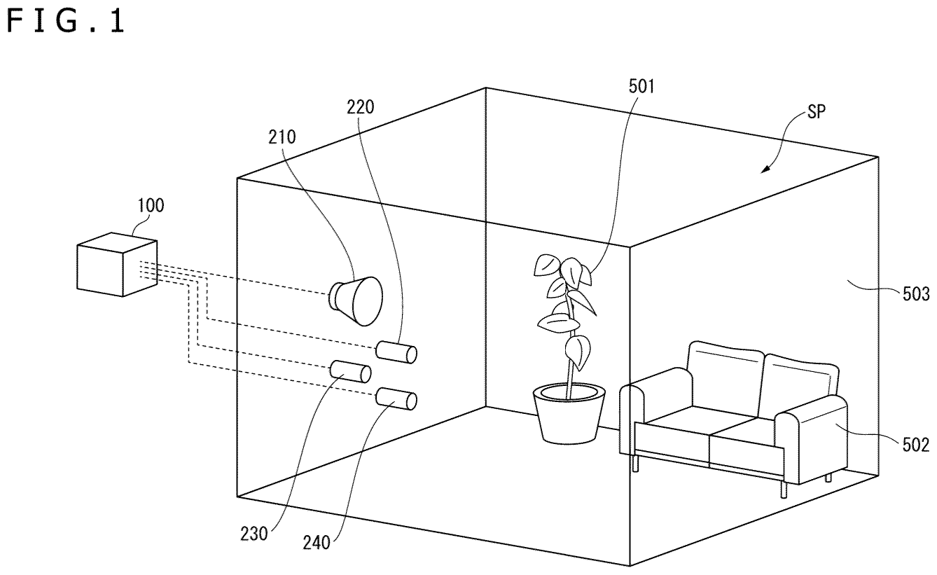

FIG. 1 is a view illustrating an example of a system according to an embodiment of the present invention. In the illustrated example, the system includes a computer 100, a speaker 210, an event-based vision sensor (EVS) 220, an RGB camera 230, and a direct Time of Flight (dToF) sensor 240. The computer 100 is, for example, a game console, a personal computer (PC), or a server apparatus connected to a network. The speaker 210, the EVS 220, the RGB camera 230, and the dToF sensor 240 are all directed toward the same space SP. That is, the speaker 210 emits sound waves to the space SP, as a sound source in the space SP, and the EVS 220, the RGB camera 230, and the dToF sensor 240 each perform imaging or measurement in the space SP.

Note that the space SP is illustrated as a closed room, but the space SP is not limited to such an example and may be a space which is at least partially open. In the illustrated example, the speaker 210, the EVS 220, the RGB camera 230, and the dToF sensor 240 are disposed on a wall surface that configures an outer edge of the space

SP, but they are not limited to being arranged as in such an example and may be arranged in an inner area of the space SP, for example. Further, the speaker 210, the EVS 220, the RGB camera 230, and the dToF sensor 240 are not necessarily required to be disposed at positions near each other, and, for example, the speaker 210 and other apparatuses may be disposed at positions separated from each other.

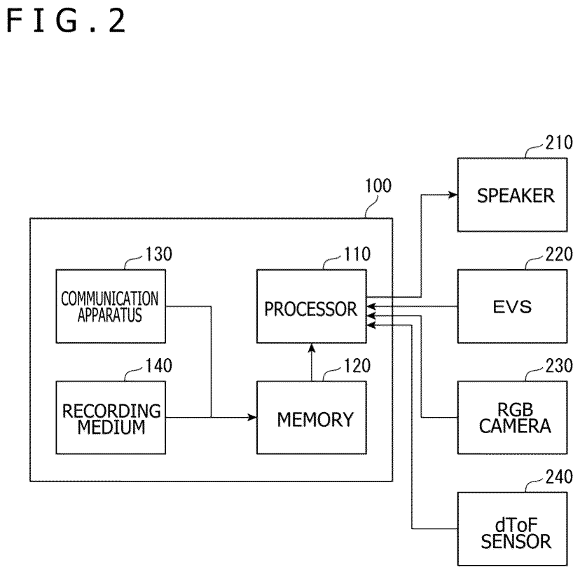

FIG. 2 is a view illustrating an apparatus configuration of the system depicted in FIG. 1. The computer 100 includes a processor 110 and a memory 120. The processor 110 includes, for example, such processing circuits as a central processing unit (CPU), a digital signal processor (DSP), an application specific integrated circuit (ASIC), and/or a field-programmable gate array (FPGA). Further, the memory 120 includes, for example, various kinds of storage devices such as a read only memory (ROM), a random access memory (RAM), and/or a hard disk drive (HDD). The processor 110 operates in accordance with a program code stored in the memory 120. The computer 100 further includes a communication apparatus 130 and a recording medium 140. For example, a program code for the processor 110 to operate as described below may be received from an external apparatus through the communication apparatus 130 and stored in the memory 120. Alternatively, the program code may be read into the memory 120 from the recording medium 140. The recording medium 140 includes, for example, a removable recording medium such as a semiconductor memory, a magnetic disk, an optical disk, or a magnetooptical disk and a driver thereof.

The speaker 210 emits sounds waves under the control of the processor 110 of the computer 100. The EVS 220 is also called an event driven sensor (EDS), an event camera, or a dynamic vision sensor (DVS), and includes a sensor array configured with sensors including light receiving elements. The EVS 220 generates an event signal including a time stamp, sensor identification information, and information concerning the polarity of the luminance change, when the sensor has detected a change in intensity of incident light, more specifically, a luminance change. Meanwhile, the RGB camera 230 is, for example, a frame-based vision sensor as exemplified by a complementary metal oxide semiconductor (CMOS) image sensor or a charge coupled device (CCD) image sensor, and obtains images of the space SP. The dToF sensor 240 includes a light source of laser light and light receiving elements, and measures a time difference between application of laser light and reception of reflection light. This time difference allows depth information of the object to be obtained. Note that the means for obtaining the depth information of the object is not limited to a dToF sensor, and for example, an indirect ToF (iToF) sensor or a stereo camera may be used.

In the present embodiment, a positional relation between the EVS 220, the RGB camera 230, and the dToF sensor 240 is known. That is, each sensor configuring the sensor array of the EVS 220 is associated with a pixel of the image obtained by the RGB camera 230. Further, a target region of the depth information of the object that is measured by the dToF sensor 240 is also associated with the pixel of the image obtained by the RGB camera 230. The processor 110 of the computer 100 associates, in terms of time, each of the outputs of the EVS 220, the RGB camera 230, and the dToF sensor 240 with use of time stamps given to each of the outputs, for example. Meanwhile, while the positional relation between the speaker 210, the EVS 220, the RGB camera 230, and the dToF sensor 240 is not necessarily required to be known, in a case where, for example, occurrence of an abnormality in the space SP is to be detected as described later, the positional relation may not be known but preferably be fixed.

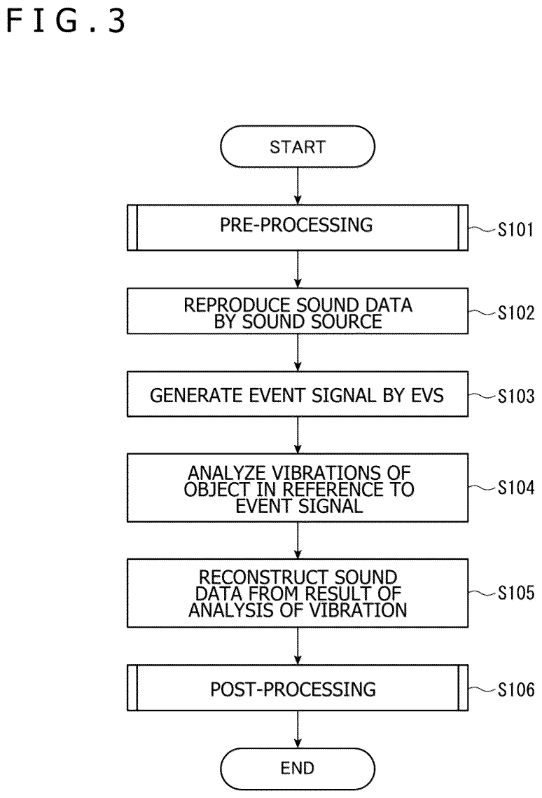

FIG. 3 is a flowchart illustrating a general flow of a process performed in the system depicted in FIG. 1. In the illustrated example, first, after carrying out, as needed, pre-processing (step S101) as the one exemplified later, the processor 110 reproduces predetermined sound data by the speaker 210 which is a sound source (step S102). Specifically, the processor 110 drives the speaker 210 via appropriate driver software in accordance with the sound data stored in the memory 120. When sound data is reproduced by the speaker 210, objects in the space SP vibrate by sound waves. In the example illustrated in FIG. 1, the objects in the space SP include a plant 510, a sofa 502, and a wall surface 503 of the room. Vibration of the object causes luminance of reflection light on a surface of the object to change, and the EVS 220 generates an event signal by a sensor located at a position corresponding to the object (Step S103).

The processor 110 of the computer 100 analyzes the vibrations of the object in reference to the event signal generated by the EVS 220 (step S104). Specifically, the processor 110 processes the vibration waveform of the object detected from the event signal, by Fast Fourier Transform (FFT), and decomposes the vibration waveform into frequency components. Further, the processor 110 reconstructs sound data from the result of analysis of the vibrations (step S105). Specifically, the processor 110, after applying a predetermined filter to the frequency components of the vibration waveform, processes the vibration wave form by inverse FTT (IFTT) and reconstructs the sound data. In a case where the pre-processing as the one exemplified later is performed, sound data can be reconstructed with higher accuracy in step S105. The processor 110 uses the reconstructed sound data to perform such postprocessing (step S106) as the one in the example described later.

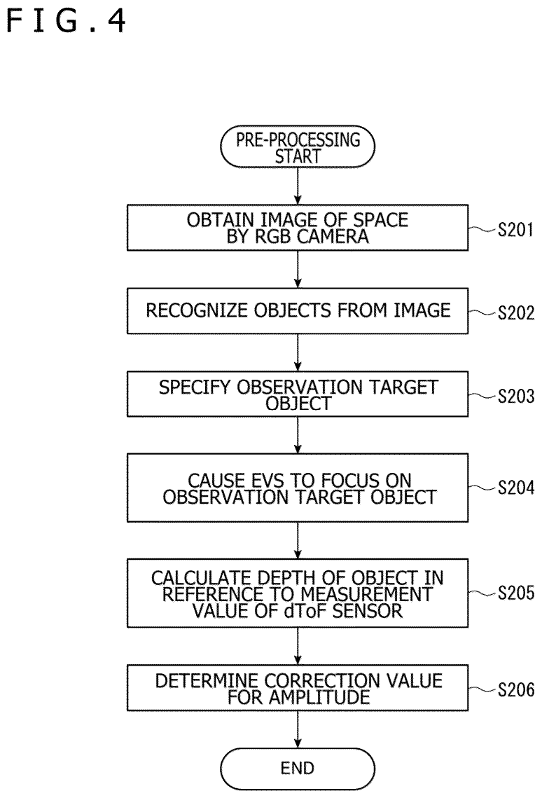

FIG. 4 is a flowchart illustrating an example of pre-processing in the process illustrated in FIG. 3. In the illustrated example, first, the RGB camera 230 obtains an image of the space SP (step S201). The processor 110 of the computer 100 recognizes objects from the image (step S202), and specifies an observation target object from the recognized objects (step S203). In step S202, a known image recognition technology can, for example, be used. In step S203, an object that vibrates relatively great with respect to the sound waves is specified as the observation target object, in reference to the material and shape of the recognized objects, for example. In the example illustrated in FIG. 1, instead of the sofa that absorbs the sound waves and does not vibrate so much, a plant that vibrates relatively great with respect to the sound waves may be selected as the target object. Alternatively, in a case where the plant is vibrating due to influence of the wind apart from the sound waves, a wall surface of the room that does not vibrate by wind may be specified as the observation targe object. For example, if the correspondence relation between the waveform of the sound waves and the vibration waveform is known for each material and shape of the object by measurement performed beforehand, applying, in step S105 illustrated in FIG. 3, a filter in which the correspondence relation in the observation target object is reflected makes it possible to reconstruct sound data with higher accuracy.

Further, the processor 110 causes the EVS 220 to focus on the observation target object (step S204). Specifically, the processor 110 drives the lens included in the optical system of the EVS 220 and magnifies the observation target object. Alternatively, the processor 110 may use an actuator and move or rotate the EVS 220 in a known amount of displacement or at a known rotation angle. Further, the processor 110 of the computer 100 calculates a depth of the object, that is, a distance from the dToF sensor 240 to the object, in reference to the measurement value obtained by the dToF sensor 240 (step S205). Since the positional relation between the EVS 220 and the dToF sensor 240 is known as described above, the calculated distance can be converted into the distance from the EVS 220 to the object. The processor 110 determines a correction value for the amplitude in the vibrations of the object in reference to the calculated depth of the object (step S206). Correcting the amplitude according to the distance from the EVS 220 to the object in the vibration waveform of the object detected from the event signal allows the vibration waveform to be closer to the vibrations actually occurring in the object, and further makes it possible to reconstruct the sound data at higher accuracy in step S105 illustrated in FIG. 3.

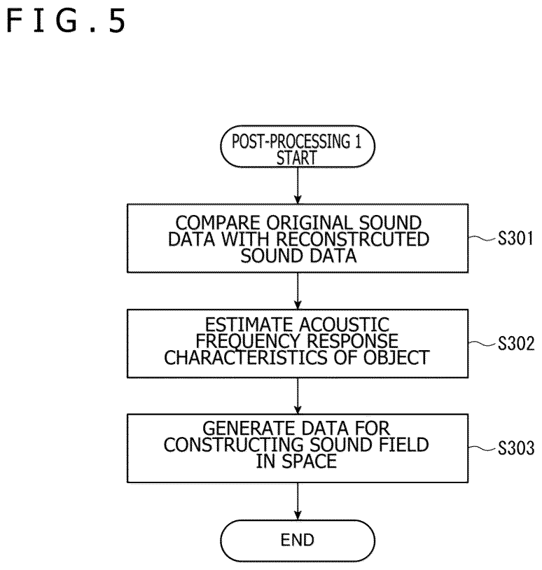

FIG. 5 is a flowchart illustrating a first example of post-processing in the process illustrated in FIG. 3. In the illustrated example, the processor 110 of the computer 100 compares the sound data reproduced by the speaker 210 in step S102 illustrated in FIG. 3 (hereinafter also referred to as the “original sound data”) with the sound data reconstructed from the result of analysis of the vibrations of the object in step S105 (hereinafter simply referred to also as the “reconstructed sound data”) (step S301). Specifically, the processor 110 compares the normalized frequency spectra of the original data and the reconstructed sound data. Between the original sound data and the reconstructed sound data, there occurs a difference in the frequency spectrum by the acoustic frequency response characteristics of the object, in addition to a time delay that occurs due to sound waves being transmitted for the distance from the speaker 210 to the object. Accordingly, the processor 110 can estimate the acoustic frequency response characteristics of the object in reference to the result of comparison in step S301 (step S302).

Further, the processor 110 may perform, for the objects in the space SP (the plant 501, the sofa 502, and the wall surface 503 of the room in the example illustrated in FIG. 1), measurement of the depth by the dToF sensor 240 and estimation of the acoustic frequency response characteristics in step S301 and step S302 described above, and generate data for constructing the sound field in the space SP (step S303). Here, the data for constructing the sound field is a parameter of a filter for processing sound data, for example. In this case, reproducing the sound data to which a filter has been applied makes it possible to reproduce the frequency response and delay characteristics that are similar to those when sound is listened to in the space SP and to thereby obtain a realistic sensation.

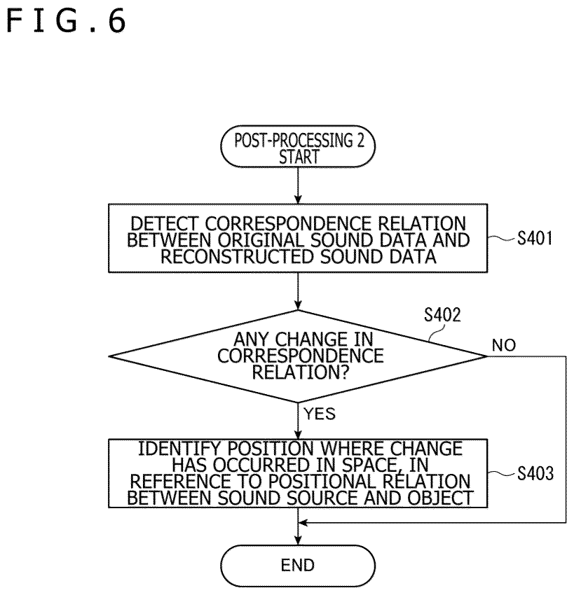

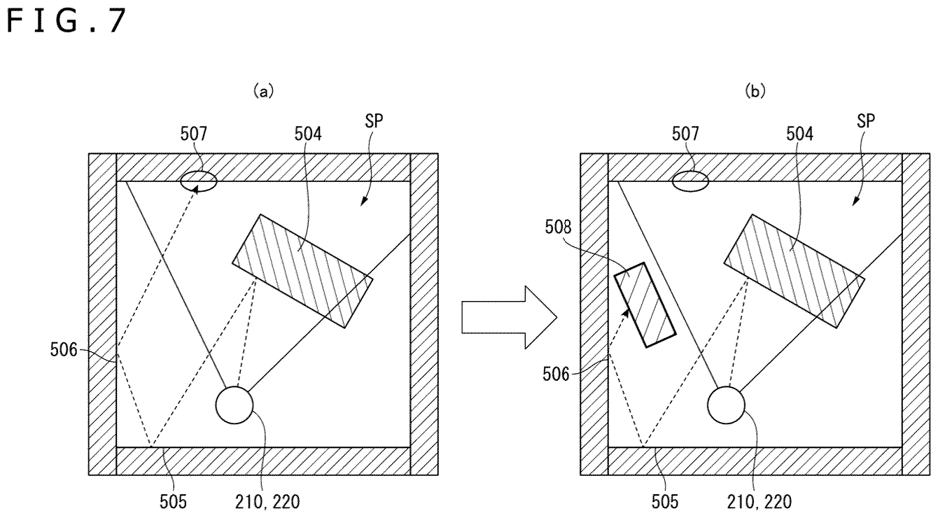

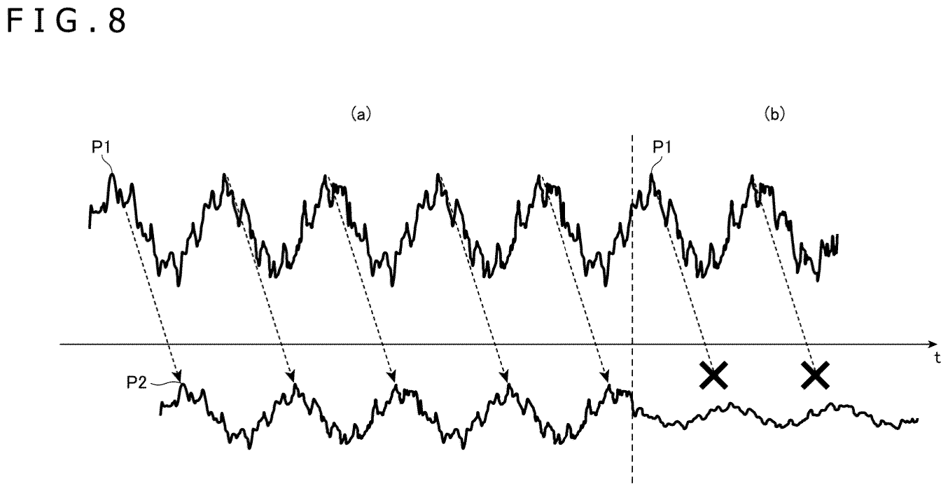

FIG. 6 is a flowchart illustrating a second example of the post-processing in the process illustrated in FIG. 3. In the illustrated example, the processor 110 of the computer 100 detects a correspondence relation between the original sound data reproduced by the speaker 210 in step S102 illustrated in FIG. 3 and the reconstructed sound data obtained by the result of analysis of the vibrations of the object in step S105 (step S401). As described above, a time delay and a difference in frequency spectrum occurs between the original sound data and the reconstructed sound data. Here, as described later with reference to FIG. 7 and FIG. 8, unless the positional relation among the objects changes in the space SP, the correspondence relation among them is a regular relation. That is, for example, in a case where the same sound data is reproduced repeatedly, the same vibration waveforms should repeatedly be observed in the objects.

As such, in the example illustrated in FIG. 6, in a case where a change occurs in the correspondence relation between the original data and the reconstructed sound data (YES in step S402), the processor 110 assumes that a change in the positional relation among the objects in the space SP has occurred, and performs predetermined processing. Specifically, in reference to the positional relation between the speaker 210 as the sound source and the objects, the processor 110 identifies the position where such a change has occurred in the space (step S403). For example, if the data for constructing the sound field in the space SP is generated in step S303 illustrated in FIG. 5, the change in correspondence relation between the original data and the reconstructed sound data can be analyzed as the change in the sound field in the space SP, and the manner of change in the positional relation among the objects in the space can be estimated. In a case where the process of step S403 described above is not performed in another example, the processor 110 may, for example, output, as an alert or a log, information indicating a change in the positional relation among the objects in the space. The processing illustrated in FIG. 6 can be used in a security system that detects an intruder to a space, for example.

FIG. 7 and FIG. 8 are each a view for describing the principle of the processing illustrated in FIG. 6. In the example illustrated in FIG. 7, the speaker 210 and the EVS 220 are disposed at positions near each other in the space SP. In a state illustrated as (a) in FIG. 7, one of the transmission paths of the sound wave emitted from the speaker 210 is reflected by an object 504, a wall surface 505, and a wall surface 506, and reaches a wall surface 507 that is an observation target object of the EVS 220. In contrast, in the state illustrated as (b) in FIG. 7, the abovementioned transmission path is blocked by an object 508 that has appeared in the space SP. In such a case, there occurs a change in the correspondence relation between the original sound data reproduced by the speaker 210 and the reconstructed sound data obtained from the vibrations of the wall surface 507.

FIG. 8 illustrates, by schematic waveforms, the correspondence relation between the original sound data and the reconstructed sound data in the case of the example illustrated in FIG. 7. Sections (a) and (b) illustrated in FIG. 8 respectively correspond to the states (a) and (b) illustrated in FIG. 7. In section (a), a peak P2 of the waveform was also observed in the reconstructed sound data at a time point obtained by adding a predetermined time delay to a time point of a peak P1 of the waveform of the original sound data. In contrast, in section (b), there was no peak in the reconstructed sound data at a time point obtained by adding a predetermined time delay to the time point of the peak P1 of the waveform of the original sound data. In the processing illustrated in FIG. 6, a change in the correspondence relation between respective items of sound data is detected in such a case, and the positional relation among the objects in the space SP is assumed to have changed.

In the embodiment of the present invention as described above, sound data is reconstructed from the vibrations of the object in the space SP that are detected from the event signal output by the EVS 220. Since the EVS 220 has high time resolution and can operate with low power compared to a frame-based vision sensor, detection accuracy can be improved while the resource amount is reduced. As the temporal resolution of the EVS 220 is, for example, in units of usec, using ultrasonic waves as the sound waves to be emitted from the speaker 210 by reproduction of sound data to perform the abovementioned process without generating audible sound in the space SP is possible. Alternatively, audible sound may be used as the sound waves to be emitted from the speaker 210 by reproduction of sound data, and the abovementioned process may be performed simultaneously with the reproduction of music in the space SP, for example.

An embodiment of the present invention has been described in detail above with reference to the attached drawings. Yet, the present invention is not limited to such an example. A person having ordinary knowledge in the technical field to which the present invention belongs can obviously arrive at various kinds of modifications and corrections within the scope of the technical idea described in the claims, and such modifications and corrections should also naturally be understood to fall within the technical scope of the present invention.

### REFERENCE SIGNS LIST

100: Computer
110: Processor
120: Memory
130: Communication apparatus
140: Recording medium
210: Speaker
220: EVS
230: RGB camera
240: Sensor
240: dToF sensor

1. A computer system for detecting vibrations generated by sound waves in a space, comprising:
a memory for storing a program code; and
a processor for performing an operation in accordance with the program code, wherein the operation includes
analyzing vibrations of an object in the space in reference to an event signal generated by an event-based vision sensor, and
reconstructing sound data from a result of the analysis of the vibration.

2. The computer system according to claim 1, wherein
the operation further includes
reproducing sound data by a sound source in the space, and
comparing the reproduced sound data and the reconstructed sound data.

3. The computer system according to claim 2, wherein
the operation further includes estimating acoustic frequency response characteristics of the object in reference to a result of the comparison.

4. The computer system according to claim 3, wherein
the operation further includes
measuring a depth of the object, and
generating data for constructing a sound field in a space including the object, in reference to the frequency response characteristics and the depth.

5. The computer system according to claim 2, wherein
the comparing includes detecting a correspondence relation between the reproduced sound data and the reconstructed sound data, and
the operation further includes performing predetermined processing in a case where a change occurs in the correspondence relation.

6. The computer system according to claim 5, wherein
reproducing the sound data includes repeatedly reproducing same sound data.

7. The computer system according to claim 5, wherein
the predetermined processing includes identifying a position where a change has occurred in the space, in reference to a positional relation between the sound source and the object.

8. The computer system according to claim 1, wherein
the operation further includes
recognizing the object from an image of the space obtained by use of a frame-based vision sensor, and
causing the event-based vision sensor to focus on the object.

9. The computer system according to claim 1, wherein
the operation further includes
measuring a depth of the object, and
determining a correction value for an amplitude of the vibrations according to the depth.

10. A method for detecting vibrations that are generated by sound waves in a space, comprising:
by an operation performed by a processor in accordance with a program code stored in a memory,
analyzing vibrations of an object in the space in reference to an event signal generated by an event-based vision sensor; and
reconstructing sound data from a result of the analysis of the vibrations.

11. A program for detecting vibrations that are generated by sound waves in a space, comprising:
by an operation performed by a processor in accordance with the program,
analyzing vibrations of an object in the space in reference to an event signal generated by an event-based vision sensor; and
reconstructing sound data from a result of the analysis of the vibrations.
